(19) United States
(12) Patent Application Publication
(10) Pub. No.: US 2003/0184661 A1
(43) Pub. Date: Oct. 2, 2003

(54) Light exposure control method, light exposure control circuit, image pickup apparatus, program and storage medium

(76) Inventors: Kouichi Yubata, Kanagawa (JP); Katsumi Katoh, Kanagawa (JP)

Correspondence Address: RADER, FISHMAN & GRAUER PLLC, Ronald P. Kananen, Suite 501, 1233 20th Street, N.W., Washington, DC, 20036, US

(21) Appl. No.: 10/395,069

(22) Filed: Mar. 25, 2003

(30) Foreign Application Priority Data
Mar. 27, 2002 (JP) P2002-087477

(51) Int. Cl. H04N 5/235

(52) U.S. Cl. 348/229.1

(57) ABSTRACT

A light exposure control method for an image pickup apparatus is disclosed by which a good image which does not suffer from saturation nor from light source flickering can be obtained over an increased range of the illuminance of an image pickup object. While the shutter speed is set to 1/100 second so as to suppress a flicker component and the gain value is controlled within a positive range so as to keep photometry data substantially fixed, an image of the image pickup object is picked up. Then, if an image pickup object illuminance acquired based on the set gain value and shutter speed and the photometry data satisfies a condition determined in advance, then the gain is changed over to a negative gain. For example, if the photometry data cannot be kept fixed any more with the set gain value, then a negative gain is set. Consequently, the signal level after the gain adjustment drops, and as a result, the photometry data can be kept fixed again. Consequently, the dynamic range of the automatic gain control function for stabilizing the image luminance with respect to the image pickup object illuminance while the image is free from flickering can be expanded.

### BACKGROUND OF THE INVENTION

This invention relates to a light exposure control method, a light exposure control circuit, an image pickup apparatus, a program and a computer-readable storage medium in which the program is stored, and more particularly to light exposure control where a function of suppressing flickering is provided making use of an electronic shutter function of an image pickup device.

An image pickup apparatus for picking up an image of an image pickup object adopts a mechanism (hereinafter referred to as incoming light amount control) for controlling the amount of light incoming to an image pickup device such as, for example, a CCD (Charge Coupled Device) image pickup device or a CMOS type image pickup device.

The incoming light amount control employs a mechanical iris mechanism or a mechanical shutter mechanism provided for an image pickup lens or an electronic shutter function which can control the accumulation time (light exposure time) of signal charge in a sensor section of an image pickup device. While they may each be used solely, the mechanical iris mechanism is sometimes used in combination with the mechanical shutter mechanism or the electronic shutter mechanism.

A basic principle of the electronic shutter is implemented by accumulating charge for a desired period of time immediately before reading out signal charge (photocharge) in a sensor section, and sweeping out signal charge preceding to the period to a different place (for example, a substrate). For example, signal charge is read out from the sensor section to a vertical transfer register at a timing synchronized with a vertical synchronizing signal VD, and at a time (light exposure timing) prior to the readout timing, a shutter pulse is applied, for example, to the substrate in order to sweep out signal charge having been accumulated in the sensor section to the substrate. The period of time from the light exposure timing to the readout timing makes a light exposure period (exposure time).

Incidentally, flickering (flickering particularly of the luminance of a screen is called luminance flickering) occurs with an image pickup apparatus when it is used to pick up an image under a light source which has a periodic light emission characteristic which is not in synchronism with the light exposure period of the image pickup device such as, for example, a fluorescent lamp although the problem does not occur when it is used under a light source whose luminosity does not vary.

The “flickering” signifies a phenomenon that an image signal varies in connection with a variation of the illuminance of the light source and the light exposure period of the image pickup apparatus. More particularly, the “flickering” is a phenomenon that a luminance signal component of a video signal is varied by a variation of the illuminance of the period of 1/nf (n usually is 2) of a light source for which typically a commercial power supply of a frequency f is used and a beat component of a field period fv of the image pickup apparatus and an output image is varied by the variation of the luminance signal component, whereupon the period of the variation of the output image has an influence of the after-image characteristic of the eyes of the human being such that the image looks flickering to the human being. Particularly in districts wherein the NTSC system is used with the field frequency of 60 Hz and the frequency f of the commercial power supply is f=50 Hz or in districts wherein the PAL system is used with the field frequency of 50 Hz and the frequency f of the commercial power supply is f=60 Hz, the flickering appears very remarkably. Besides, the flickering appears more remarkably with a fluorescent lamp than with an incandescent lamp because it has an illuminance variation from the light emission characteristic thereof.

For example, if it is assumed that the light emission period of the fluorescent lamp is 10 ms and one period of the light exposure operation in 60 Hz is 16.7 ms, then the lowest common multiple of them is 50 ms. Therefore, the relationship between them returns to its initial state through three light exposure operations. Accordingly, three different light exposure periods are involved, and flickering of 20 Hz is generated from the different in the output signal level of the image pickup device among them.

On the other hand, where the electronic shutter function is used, as the shutter speed increases, the accumulation time within which charge is accumulated in the image pickup device within one field period. Therefore, the amplitude of flickering becomes greater than that where the shutter speed is an ordinary speed of 1/60 second. Thus, as the shutter speed of the electronic shutter increases, flickering appears more conspicuously, and such flickering on the screen (particularly flickering of the luminance of the screen) considerably deteriorates the picture quality.

Meanwhile, fluorescent materials having different three colors of green, red and blue are used for a fluorescent lamp, and although they begin to emit light of the colors at the same timing, the period in which the light amount decreases finally to zero differs among them. Usually, among the three colors, the light emission period for green is longest, and that for red is second longest whereas that for blue is shortest. Accordingly, depending upon the shutter timing of a high speed shutter, it sometimes occurs that only a light component of one color or light components of two colors from among the emission light of the different colors can be picked up.

In other words, the emission light color components of the fluorescent light, that is, the color temperature, is different among different fields, and when a white balance process which is essentially required for an image pickup apparatus for a color image is performed, the white balance varies for each one field. Accordingly, the image signal suffers from flickering of the color components in a period similar to that of the luminance flickering described above. In the description given below, such flickering of a color signal component or components is referred to as color flickering, and the luminance flickering described hereinabove and the color flickering are collectively referred to as light source flickering.

As one of techniques for preventing such light source flickering as described above, a method of changing over the shutter mode of an image pickup device in response to a blinking period of a light source is widely known. For example, in a 50 Hz power supply district of the NTSC system specifications, the shutter mode is set to 1/100 second. Since the electronic shutter speed of 1/100 synchronizes with the fluorescent lamp blinking period of 1/100 second, in whatever manner the phase of the operation of the electronic shutter and the phase of the blinking of the fluorescent lamp are displaced from each other, the amount of light incoming to the image pickup device is kept fixed for a period of time of 1/100 second which is the fixed shutter speed of the electronic shutter, and consequently, light source flickering (both of luminance flickering and color flickering) does not occur.

In this instance, however, although light source flickering can be prevented, light exposure control which utilizes an electronic shutter is impossible. Therefore, on the high side of the illuminance of the image pickup object, the image pickup device sometimes suffer from electronic saturation as the illuminance increases. Or even if the image pickup device is not saturated, a signal processing system at the following stage may suffer from saturation. In those cases, the image luminance may increase until the image may collapse in a whitish color.

As a countermeasure against this, it is a possible idea to combine an image pickup device with a mechanical iris to effect light exposure control so that collapse of an image may not occur while power supply flickering is prevented. Nowadays, however, in order to reduce the cost of an image pickup apparatus body, light exposure control is performed in most cases with an electronic shutter function built in an image pickup device while a mechanical iris mechanism (mechanical iris) is removed. Such light exposure control is hereinafter referred to as electronic iris.

It is a possible idea that such an image pickup apparatus which uses an electronic iris to effect light exposure control without using an mechanical iris mechanism as described above performs automatic gain control of a signal outputted from the image pickup device as a technique for keeping the image luminance fixed irrespective of a variation of the illuminance of the image pickup object as far as the image pickup device does not suffer from saturation upon prevention of light source flickering. In the following description, the term “light exposure control” is used to include not only incoming light amount control of controlling the incoming light amount to an image pickup device but also such automatic gain control as just mentioned.

However, even if the automatic gain control functions, if the illuminance of the image pickup object increases to a higher illuminance side than an object illuminance range within which the automatic gain control operates, then the AGC gain becomes fixed to 0 db of a lower limit value to the gain, and therefore, as the illuminance increases, the image luminance increases. If a mechanical iris is used, then the incoming light amount can be controlled to keep the image luminance at an appropriate level so that the image may not suffer from saturation. However, since most image pickup apparatus in recent years do not include a mechanical iris, they cannot prevent an increase of the image luminance (a saturation phenomenon).

In this instance, if the shutter speed is set faster than the blinking period of the light source, then saturation of the image at a high luminance portion can be prevented. However, as the shutter speed is raised, the accumulation time within which electric charge is accumulated into the image pickup device within one field period is reduced as much, and light source flickering becomes conspicuous.

In this manner, with a conventional image pickup apparatus wherein an electronic iris is used for light exposure control, even if the automatic gain control functions, the image luminance can be kept fixed irrespective of a variation of the illuminance of the image pickup object only where the illuminance of the image pickup object remains within a certain range. Consequently, there is a limitation to the adaptable range of the illuminance of the image pickup object, and particularly on the higher illuminance side, even if light source flickering occurs, only it is possible to use an appropriate image illuminance or alternatively suppress light source flickering even if the image may suffer from somewhat saturation.

### SUMMARY OF THE INVENTION

It is an object of the present invention to provide a light exposure control method, a light exposure control circuit, an image pickup apparatus, a program and a computer-readable storage medium by which a good image which does not suffer from saturation nor from light source flickering can be obtained over an increased range of the illuminance of an image pickup object.

In order to attain the objects described above, according to an aspect of the present invention, there is provided a light exposure control method, including the steps of acquiring photometry data based on an image pickup signal from an image pickup device and picking up an image of an image pickup object while a gain value of a predetermined image signal based on the image pickup signal is controlled within a positive range (including 0 dB) so that the photometry data may be kept substantially fixed and a shutter speed of an electronic shutter of the image pickup device is synchronized with a period of blinking of a light source (the shutter speed is set so as to correspond, for example, to twice the frequency of a power supply for driving the light source) so that a flickering component originating from the blinking of the light source may be suppressed, and changing over the gain value of the image signal to a negative gain when an illuminance of the image pickup object acquired based on three different kinds of information including the gain value set for the image signal, the shutter speed set so as to be synchronized with the period of the blinking of the light source and the photometry data satisfy a condition determined in advance.

According to another aspect of the present invention, there is provided a light exposure control circuit, including a gain control section for controlling, based on photometry data acquired based on an image pickup signal from an image pickup device, a gain value of a predetermined image signal based on the image pickup signal so that the photometry data may be kept substantially fixed and a flickering component originating from blinking of a light source may be suppressed, a shutter speed setting section for changing over a shutter speed of an electronic shutter of the image pickup device, and a light exposure control section for determining a combination of a gain value to be set to the gain control section and a shutter speed to be set to the shutter speed setting section with which the flickering component originating from the blinking of the light source (the shutter speed is set so as to correspond, for example, to twice the frequency of a power supply for driving the light source) can be suppressed and issuing an instruction of a negative gain value to the gain control section when an illuminance of an image pickup object acquired based on three different kinds of information including the gain value set to the gain control section, the shutter speed set to the shutter speed setting section and synchronized with the blinking of the light source and the photometry data acquired based on the image pickup signal satisfies a condition determined in advance.

According to a further aspect of the present invention, there is provided an image pickup apparatus for picking up an image of an image pickup object illuminated by a light source, including an image pickup device including an electronic shutter having an adjustable shutter speed, an image signal processing section for producing an image based on an image pickup signal from the image pickup device, a photometry section for acquiring photometry data based on the image pickup signal from the image pickup device, a gain control section for controlling a gain value of a predetermined image signal based on the image pickup signal, a shutter speed setting section for changing over the shutter speed of the electronic shutter of the image pickup device, and a light exposure control section for determining, based on the photometry data acquired by the photometry section, a combination of a gain value for the gain control section with which the photometry data can be kept substantially fixed and a flickering component originating from blinking of the light source can be suppressed and a shutter speed with which the flickering component originating from the blinking of the light source can be suppressed (the shutter speed is set so as to correspond, for example, to twice the frequency of a power supply for driving the light source) and for issuing an instruction to the shutter speed setting section to change over the shutter speed to the determined shutter speed and notifying the gain control section of the determined gain value, the light exposure control section issuing an instruction of a negative gain value to the gain control section when an illuminance of an image pickup object acquired based on three different kinds of information including the gain value set to the gain control section, the shutter speed set to the shutter speed setting section and synchronized with the blinking of the light source and the photometry data acquired by the photometry section satisfies a condition determined in advance.

According to a further aspect of the present invention, there is provided a program for causing a computer to execute a light exposure control process for adjusting a shutter speed of an image pickup device and a gain of an image pickup signal obtained by the image pickup device, the program causing the computer to function as a light exposure control section for determining a combination of a gain value to be set to a gain control section, which is provided for controlling a gain value of a predetermined image signal, which is based on an image pickup signal from the image pickup device, based on photometry data acquired based on the image pickup signal by a photometry section so that the photometry data may be kept substantially fixed and a flickering component originating from blinking of a light source may be suppressed and a shutter speed which is to be set to a shutter speed setting section, which is provided for changing over the shutter speed of an electronic shutter of the image pickup device and with which the flickering component originating from the blinking of the light source can be suppressed and issuing an instruction of a negative gain value to the gain control section when an illuminance of an image pickup object acquired based on three different kinds of information including the gain value set to the gain control section, the shutter speed set to the shutter speed setting section and synchronized with the blinking of the light source and the photometry data acquired by the photometry section satisfies a condition determined in advance.

According to a yet further aspect of the present invention, there is provided a computer-readable storage medium in which a program for causing a computer to execute a light exposure control process for adjusting a shutter speed of an image pickup device and a gain of an image pickup signal obtained by the image pickup device is stored, the program causing the computer to function as a light exposure control section for determining a combination of a gain value to be set to a gain control section, which is provided for controlling a gain value of a predetermined image signal, which is based on an image pickup signal from the image pickup device, based on photometry data acquired based on the image pickup signal by a photometry section so that the photometry data may be kept substantially fixed and a flickering component originating from blinking of a light source may be suppressed and a shutter speed which is to be set to a shutter speed setting section, which is provided for changing over the shutter speed of an electronic shutter of the image pickup device and with which the flickering component originating from the blinking of the light source can be suppressed, and issuing an instruction of a negative gain value to the gain control section when an illuminance of an image pickup object acquired based on three different kinds of information including the gain value set to the gain control section, the shutter speed set to the shutter speed setting section and synchronized with the blinking of the light source and the photometry data acquired by the photometry section satisfies a condition determined in advance.

With the light exposure control method, light exposure control circuit, image pickup apparatus, program and computer-readable storage medium of the present invention, while the shutter speed is set so as to suppress a flickering component and the gain value is controlled so as to keep the photometry data substantially fixed, an image of an image pickup object is picked up in this state. Then, if an image pickup object illuminance acquired based on the set gain value and shutter speed and the photometry data satisfies a condition determined in advance, then the gain is changed over to a negative gain. For example, the shutter speed is set to a value with which a flickering component can be suppressed, and an image of the image pickup object is picked up while the gain value is controlled within the positive range. Then, if the relationship of the gain value, shutter speed and photometry data satisfies the condition determined in advance, particularly if the photometry data cannot be kept fixed any more with the set gain value, then a negative gain is set. Consequently, the photometry data can be kept fixed again.

In summary, according to the present invention, since AGC control and shutter speed changeover are combined and, when the illuminance is within a predetermined range, the combination is further combined with negative gain setting, light exposure control can be achieved by which the brightness of the image is kept at an appropriate level without suffering from flickering or saturation of the image over a wide range of the illuminance.

The above and other objects, features and advantages of the present invention will become apparent from the following description and the appended claims, taken in conjunction with the accompanying drawings in which like parts or elements denoted by like reference symbols.

### BRIEF DESCRIPTION OF THE DRAWINGS

FIG. 1 is a block diagram of an image pickup apparatus to which the present invention is applied;

FIGS. 2A and 2B are flow diagrams illustrating a light exposure control function of the image pickup apparatus of FIG. 1;

FIGS. 3A, 3B and 3C are characteristic diagrams illustrating a relationship between an electronic shutter function and an AGC function of light exposure control by a light exposure control section of the image pickup apparatus of FIG. 1;

FIG. 4 is a flow chart illustrating a main process of a processing procedure of the light exposure control by the light exposure control section shown in FIG. 1;

FIG. 5 is a flow chart illustrating an example of an initialization process in the main process illustrated in FIG. 4;

FIG. 6 is a flow chart illustrating an example of an AGC control process in the main process illustrated in FIG. 4;

FIG. 7 is a flow chart illustrating an example of a negative gain changeover discrimination process in the main process illustrated in FIG. 4;

FIG. 8 is a flow chart illustrating an example of a negative gain/digital AGC changeover process in the main process illustrated in FIG. 4;

FIG. 9 is a flow chart illustrating an example of a shutter speed control process in the main process illustrated in FIG. 4;

FIGS. 10A and 10B are flow diagrams showing another image pickup apparatus to which the present invention is applied; and

FIG. 11 is a block diagram showing a further image pickup apparatus to which the present invention is applied.

### DETAILED DESCRIPTION OF THE PREFERRED EMBODIMENTS

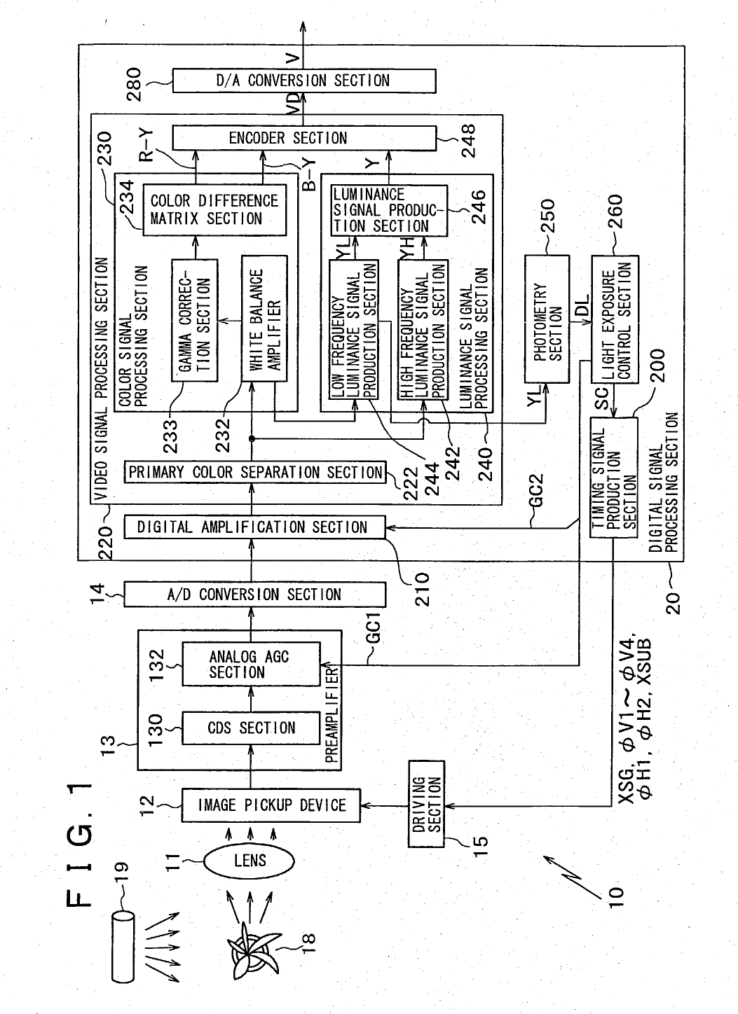

FIG. 1 shows an image pickup apparatus to which the present invention is applied. Referring to FIG. 1, an image pickup apparatus 10 of the first embodiment includes a lens 11 for condensing reflection light from an image pickup object 18 illuminated by a fluorescent lamp 19 which is an example of a light source, an image pickup device 12 which performs photoelectric conversion for an optical image obtained through the lens 11, a preamplifier 13 for amplifying an analog image pickup signal from the image pickup device 12, an analog to digital (A/D) conversion section 14 for converting the analog image pickup signal from the preamplifier 13 into a digital signal, a driving section 15 for driving the image pickup device 12, and a digital signal processing section (DSP; Digital Signal Processor) 20 which includes a timing signal production section 200, a light exposure control section 260 and so forth.

In the image pickup apparatus 10 having the configuration described above, the lens 11 causes an image of the image pickup object 18 to be formed on an image pickup face of the image pickup device 12. A solid-state image pickup device such as a CCD (Charge Coupled Device) image pickup device, a CMOS (Complementary Metal Oxide Semiconductor) type image pickup device or the like is used as the image pickup device 12. The image pickup device 12 is driven by the driving section 15 based on several timing signals produced by the timing signal production section 200, converts an image pickup object image formed on the image pickup face thereof into an electric signal in a unit of a pixel and supplies it to the preamplifier 13 as an image pickup signal.

Where a CCD image pickup device is used as the image pickup device 12, the timing signal production section 200 produces a readout pulse XSG for reading out signal charge accumulated in sensor sections of the image pickup device 12, vertical transfer clocks φV1 to φV4 (in the case of four phase driving), horizontal transfer clocks φH1 and φH2 (in the case of two phase driving), a shutter pulse XSUB for determining an electronic shutter speed and so forth and supplies them to the driving section 15. The driving section 15 converts the several pulses supplied thereto from the timing signal production section 200 into voltage signals having predetermined levels and supplies them to the image pickup device 12.

The image pickup device 12 has an electronic shutter function of applying the shutter pulse XSUB to a substrate so that the substrate sweeps out the signal charge accumulated in the sensor sections to the substrate thereby to control the accumulation time (light exposure time) of signal charge in the sensor sections. In particular, while, upon normal operation, the substrate is biased with a fixed set voltage (substrate voltage) so that the signal charge is accumulated in the sensor sections, since, upon electronic shutter operation, the shutter pulse XSUB is added to the substrate voltage, a barrier on the substrate side collapses and the signal charge accumulated in the sensor sections is swept out into the substrate.

The preamplifier 13 includes a correlated double sampling (hereinafter referred to as CDS) section 130 for converting an intermittent image pickup signal from the image pickup device 12 whose magnitude varies in accordance with the intensity of incoming light into a continuous image pickup signal, and an analog AGC (Auto Gain Control) section 132 for gain-controlling the signal level of the analog image pickup signal from the CDS section 130 to a predetermined level.

The preamplifier 13 performs a sample hold process for the image pickup signal outputted from the image pickup device 12 by means of the CDS section 130 to extract necessary data, and performs gain control for the data by means of the analog AGC section 132 to adjust the level of the data to a proper level. An output signal of the preamplifier 13 is supplied to the A/D conversion section 14. The A/D conversion section 14 converts the output signal of the preamplifier 13 from an analog signal into a digital signal and supplies the resulting signal to the digital signal processing section 20.

The digital signal processing section 20 includes a timing signal production section (timing generator; TG) 200 having a function of a shutter speed setting section for setting the electronic shutter speed for the image pickup device 12, and a digital amplification section 210 for performing gain control for the digital image pickup signal from the A/D conversion section 14 so as to have a predetermined level. In the first embodiment, the digital amplification section 210 functions as an automatic gain control section according to the present invention.

The timing signal production section 200 receives an electronic shutter control signal SC from the light exposure control section 260, and produces a shutter pulse XSUB which corresponds to a shutter speed represented by a shutter speed variable SS included in the electronic shutter control signal SC and supplies the shutter pulse XSUB together with several pulse signals such as the readout pulse XSG, vertical transfer clocks φV1 to φV4 and horizontal transfer clocks φH1 and φH2 to the driving section 15. The driving section 15 produces a driving pulse signal having a predetermined level based on the several pulse signals supplied from the timing signal production section 200 and supplies it to the image pickup device 12.

Further, the digital signal processing section 20 includes a video signal processing section (camera signal processing section) 220 and a D/A conversion section 280. The video signal processing section (camera signal processing section) 220 includes a primary color separation section 222 for separating the digital image pickup signal supplied from the A/D conversion section 14 into primary color signals of R (red), G (green) and B (blue), a color signal processing section 230 and a luminance signal processing section 240 for producing color signals and a luminance signal based on the primary color signals from the primary color separation section 222, respectively, and an encoder section 248 for producing a video signal VD based on the luminance signal and the color signals.

Alternatively, the A/D conversion section 14 may be provided in the digital signal processing section 20, and also the D/A conversion section 280 may be provided on the outside of the digital signal processing section 20.

The color signal processing section 230 includes a white balance amplifier 232, a gamma correction section 233, a color difference matrix section 234 and so forth. The white balance amplifier 232 adjusts (white balance adjustment) the gains of the primary color signals supplied from the primary color separation section 222 based on a gain signal supplied from a white balance controller not shown and supplies the resulting primary color signals to the gamma correction section 233 and the luminance signal processing section 240.

The gamma correction section 233 performs, based on the primary color signals whose white balance has been adjusted, gamma (γ) correction for faithful rendition of colors, and inputs output signals R, G and B for the colors to which the gamma correction has been performed to the color difference matrix section 234. The color difference matrix section 234 inputs color difference signals R-Y and B-Y obtained by performing a color difference matrix process for the output signals R, G and B to the encoder section 248.

The luminance signal processing section 240 has a high frequency luminance signal production section 242 for producing a luminance signal YH including a component of a comparatively high frequency based on the primary color signals supplied from the primary color separation section 222, a low-frequency luminance signal production section 244 for producing a luminance signal YL which only includes a component of a comparatively low frequency based on the primary color signals, whose white balance has been adjusted, supplied from the white balance amplifier 232, and a luminance signal production section 246 for producing a luminance signal Y based on the two different luminance signals YH and YL and supplying it to the encoder section 248.

The encoder section 248 performs digital modulation for the color difference signals R-Y and B-Y with a digital signal corresponding to a color signal subcarrier, and synthesizes them with the luminance signal Y produced by the luminance signal processing section 240 to convert them into a digital video signal VD (=Y+S+C; S is a synchronizing signal, C is a chroma signal) and inputs it to the D/A conversion section 280. The D/A conversion section 280 converts the digital video signal VD into an analog video signal V.

Further, the digital signal processing section 20 includes a photometry section 250 for acquiring photometry data DL which indicates an image pickup object illuminance based on the luminance signal YL which is an example of an output signal from the digital amplification section 210, and a light exposure control section 260 for determining a combination of an electronic shutter speed synchronized with a blinking period of, for example, a fluorescent lamp 19 as a light source and a gain value in the digital amplification section 200 so as to keep the photometry data DL obtained by the photometry section 250 substantially fixed, and issuing a notification of an electronic shutter control signal SC which indicates the determined electronic shutter speed to the timing signal production section 200 and issuing an instruction of a gain control signal GC2 which indicates the determined gain value to the digital amplification section 210.

The electronic shutter control signal SC includes a shutter speed variable SS which indicates an electronic shutter speed. The gain control signal GC2 includes an AGC gain variable GG which is a set value of a digital gain for a digital AGC section 212 hereinafter described and a changeover signal for setting a negative gain for a negative gain changeover section 214 hereinafter described.

The photometry section 250 has functions such as screen division photometry, luminance peek detection, integration data outputting and so forth, and receives signal amplitude data of the luminance signal YL being currently processed from the luminance signal processing section 240, integrates the luminance signal YL to acquire photometry data DL corresponding to an image pickup object illuminance and outputs it to the light exposure control section 260.

The light exposure control section 260 outputs, based on the photometry data DL inputted from the photometry section 250, the gain control signal GC2 to the digital amplification section 210 so that the value of the photometry data DL is always fixed, and outputs the electronic shutter control signal SC to the timing signal production section 200. It is to be noted that, when necessary, the light exposure control section 260 outputs the gain control signal GC1 also to the analog AGC section 132.

A series of image pickup operations of the image pickup apparatus 10 configured as described above is described below simply. An optical image of the image pickup object 18 incoming through an optical system such as the lens 11 is formed on the image formation face of the image pickup device 12. The image pickup device 12 is driven in response to the several timing signals from the timing signal production section 200, and outputs an analog image pickup signal corresponding to the optical image formed on the image formation face of the image pickup device 12. While such analog image pickup signals are outputted from the image pickup device 12 but not continuously, they are converted into a continuous analog image pickup signal by the CDS section 130, and the continuous signal is inputted to the analog AGC section 132.

The analog AGC section 132 amplifies the analog image pickup signal based on the gain control signal GC1 from the light exposure control section 260. For example, if the gain control signal GC1 is in an active state, then the analog AGC section 132 performs the automatic gain control so that the output level may be fixed. The amplified analog image pickup signal is converted into a digital image pickup signal by the A/D conversion section 14 and inputted to the digital signal processing section 20.

In the digital signal processing section 20, required processes are performed for the color components and the luminance components of the digital image pickup signal by the color signal processing section 230 and the luminance signal processing section 240, respectively. Then, the analog video signal V obtained by the processes of the digital signal processing section 20 is outputted to some other functioning section in the image pickup apparatus 10, or outputted to the outside of the apparatus through an output terminal not shown. Further, the digital signal processing section 20 supplies the luminance signal YL to the photometry section 250.

The photometry section 250 integrates a desired portion of the inputted luminance signal YL (for example, in accordance with a photometry pattern) and supplies photometry data DL as a measurement value of an image pickup object illuminance to the light exposure control section 260. The light exposure control section 260 supplies the gain control signal GC2 to the digital amplification section 210 so that the value of the photometry data DL may be fixed and supplies the electronic shutter control signal SC to the timing signal production section 200.

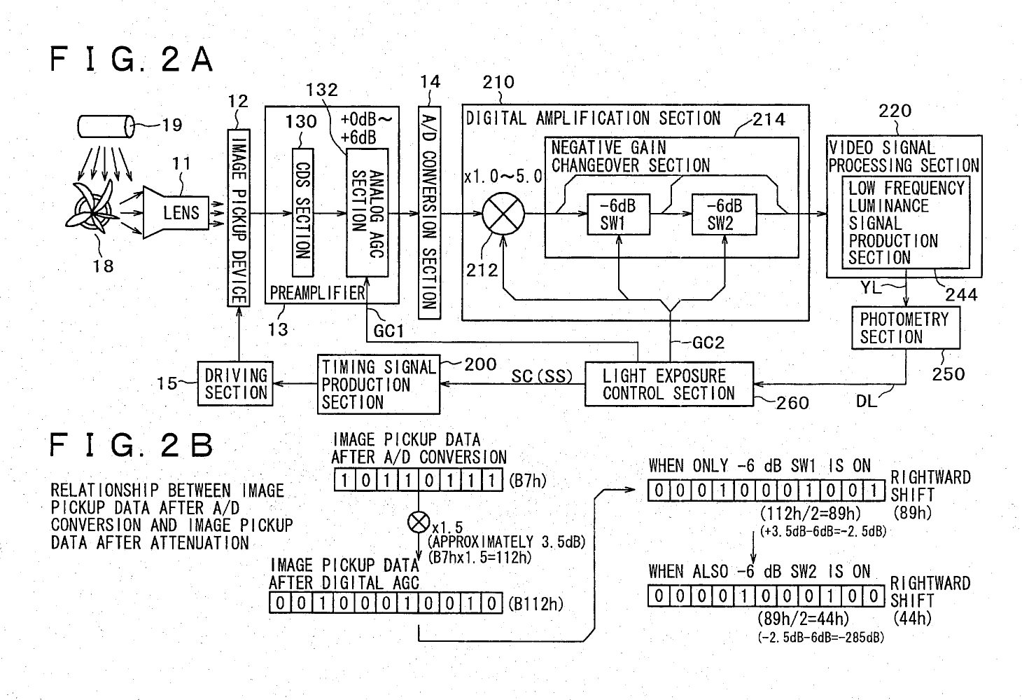

FIGS. 2A and 2B illustrate the light exposure control function of the image pickup apparatus 10. More particularly, FIG. 2A illustrates functional blocks relating to the light exposure control function and FIG. 2B illustrates a relationship between image pickup data immediately after A/D conversion and image pickup data processed by the digital amplification section 210.

Referring first to FIG. 2A, an optical image of an image pickup object 18 illuminated by the fluorescent lamp 19 is formed on the image pickup device 12, and an analog image pickup signal acquired by the image pickup device 12 is inputted to the analog AGC section 132. When the gain control signal GC1 from the light exposure control section 260 is active (on), the analog AGC section 132 automatically controls the gain of the analog image pickup signal so that the signal level at an output terminal thereof may be fixed within a range from “+0 db to +6 dB”. However, when the gain control signal GC1 is inactive (off), the analog AGC section 132 automatically controls the gain to “+0 db”, that is, outputs the image pickup signal inputted thereto as it is with the equal signal level. The image pickup signal outputted from the analog AGC section 132 is digitized by the A/D conversion section 14 and inputted to the digital amplification section 210.

The digital amplification section 210 includes a digital AGC section 212 for amplifying the signal level within a range from ×1.0 (non-magnification: +0 db) to ×5.0 times (+14 dB), and a negative gain changeover section 214 for amplifying (actually attenuating) the signal level with one of ×1.0 time (non-magnification: +0 dB), ×½ time (−6 dB) and ×¼ time (−12 dB) and supplying the amplified signal to the video signal processing section 220.

Gain setting to the digital AGC section 212 is performed with an AGC gain variable GG included in the gain control signal GC2 from the light exposure control section 260. Further, the negative gain changeover section 214 changes over the attenuation degree by bit shifting of digital data. To this end, the gain control signal GC2 is inputted form the light exposure control section 260 to the negative gain switches SW1 and SW2 of the negative gain changeover section 214.

When one of the negative gain switches SW1 and SW2 is active (on), the negative gain changeover section 214 shifts the digital data rightwardly (to the LSB side) by one bit to reduce the digital data to ×½ time (−6 dB). However, when both of the negative gain switches SW1 and SW2 are active (on), the negative gain changeover section 214 shifts the digital data rightwardly (to the LSB side) by 2 bits to reduce the digital data to ×l/4 time (−12 dB). In this manner, negative gain changeover can be achieved readily by digitally reducing data after A/D conversion to ½ or ¼ (by performing rightward shifting of the data).

For example, if image pickup data of “B7h” (h represents hexadecimal notation: this similarly applies in the following description) is inputted from the A/D conversion section 14 to the digital amplification section 210 and amplified to ×1.5 times (approximately +3.5 dB) by the digital AGC section 212 as seen in FIG. 2B, then image pickup data of “112h” is outputted from the digital AGC section 212.

When only the negative gain switch SW1 is active, the negative gain changeover section 214 shifts the digital data rightwardly by 1 bit and outputs image pickup data of “89h”, but when also the negative gain switch SW2 is active (on), the negative gain changeover section 214 shifts the digital data rightwardly by 2 bits and outputs image pickup data of “44h”. In this instance, the image pickup data “B7h” after A/D conversion is resultantly converted into image pickup data “44h” attenuated to “−8.5 dB”.

Subsequently, the light exposure control function of the image pickup apparatus 10 is described in detail. It is to be noted that, in the embodiment described below, the image pickup apparatus 10 uses an image pickup device 12 which is driven with a field rate (vertical frequency) of 60 Hz. Further, the light exposure control function of the image pickup apparatus 10 is implemented by electronic iris control based on a combination of AGC (automatic gain control) and changeover of the electronic shutter speed without using a mechanical iris mechanism (mechanical iris) in order to achieve a low cost.

If the image pickup apparatus 10 driven with 60 Hz is used in a district where the frequency of the commercial power supply is 60 Hz (for example, in the west part of Japan), light source flickering occurs little even if the electronic shutter speed is set to an arbitrary value, but if the image pickup apparatus 10 is used in another district where the frequency of the commercial power supply is 50 Hz (for example, in the east part of Japan), then if a combination of a fluorescent lamp 19 which emits light with 100 Hz and the image pickup device 12 which performs light exposure operation with 60 Hz is taken as an example, then since three different light exposure periods are involved, the difference in the level of the image pickup signal from the image pickup device 12 among them gives rise to flickering.

In the image pickup apparatus 10 of the present embodiment, where the frequency relationship described above is satisfied, the electronic shutter speed is set to a speed synchronized with the frequency of the commercial power supply (1/50 or 1/100 second is particularly effective) to adjust the level of the image pickup signal to suppress flickering. It is to be noted that, since it is well known in the art that flickering can be suppressed if the electronic shutter speed is set to 1/50 or 1/100 second, detailed description thereof is omitted herein. Further, if the electronic shutter speed is set to 1/50 second, then since the light exposure time becomes longer than the field rate, if the image pickup object 18 is moving when an image thereof is picked up, then the image suffers from flickering.

Further, the amplification gain of the digital amplification section 210 is controlled so that the absolute level of the image pickup signal having the adjusted level (more particularly, the luminance signal YL produced by the low frequency luminance signal production section 244) may be kept at a predetermined level.

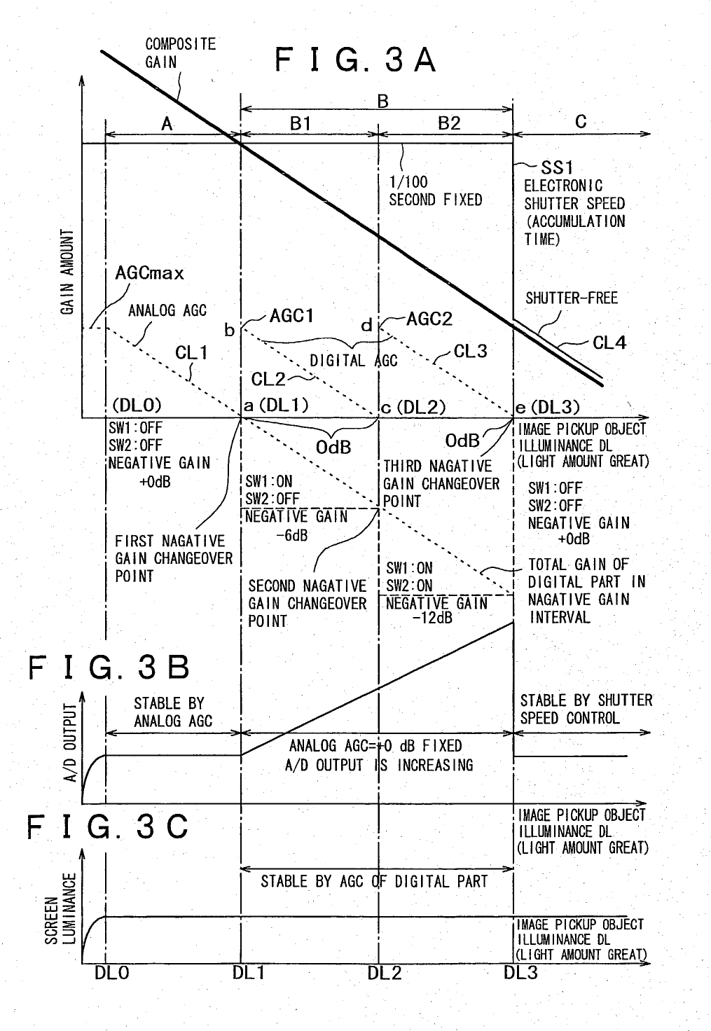

FIGS. 3A to 3C are characteristic diagrams illustrating a relationship between the electronic shutter function of the light exposure control and the AGC (automatic gain control) function by the light exposure control section 260. Particularly, the axis of abscissa of the characteristic diagram of FIG. 3A represents the illuminance of the image pickup object (light mount inputted to the image pickup device 12), and the axis of ordinate represents the gain amount (AGC amount). It is to be noted that also a changeover curve SS (Shutter Speed) of the electronic shutter speed (accumulation time of charge in the image pickup device 12) and a characteristic curve CL0 (CL; Characteristic Line) of the composite gain are shown in a corresponding relationship to the illuminance of the image pickup object of the axis of abscissa. In other words, FIG. 3A illustrates a relationship between the illuminance of the image pickup object and the AGC gain corresponding to the changeover of the shutter speed.

The axis of abscissa of the characteristic diagram of FIG. 3B represents the illuminance of the image pickup object, and the axis of ordinate represents the level of the digital image pickup signal inputted from the A/D conversion section 14. Thus, FIG. 3B illustrates a relationship between the illuminance of the image pickup object and the image pickup signal inputted to the digital part. Meanwhile, the axis of abscissa of the characteristic diagram of FIG. 3C represents the illuminance of the image pickup object, and the axis of ordinate represents the brightness of the image (that is, the image luminance). Thus, FIG. 3C illustrates a relationship between the illuminance of the image pickup object and the image luminance.

An image pickup object luminance higher than DL1 corresponds to 1/100 second which is an original first shutter speed; another image pickup object luminance higher than DL2 corresponds to 1/200 second which is an original second shutter speed; and a further image pickup object luminance higher than DL3 corresponds to 1/400 second which is an original third shutter speed. Here, the term “original” signifies a preset value when a speed synchronized with the blinking period of the fluorescent lamp 19 serving as a light source is selected as the electronic shutter speed in response to the image pickup object luminance without taking prevention of flickering into consideration at all.

Where the image pickup object illuminance is lower than DL1 or higher than DL3, the total AGC gain of the digital part is set to “+0 db”. On the other hand, where the image pickup object illuminance is lower than DL0, if the gain control signal GC1 from the light exposure control section 260 is active, then the AGC gain of the analog AGC section 132 is set to a gain upper limit value AGCmax (in the present example, +6 dB).

In the interval where the image pickup object illuminance is lower than DL0, since correction by analog AGC is insufficient, the brightness of the screen (image luminance) drops as seen in FIG. 3B. It is to be noted that, where the image pickup object illuminance is lower than DL0, the electronic shutter speed may be set to 1/50 second or digital AGC may be rendered operative to extend the range within which the brightness of the image is kept fixed further to the low illuminance side.

Where the image pickup object illuminance is within the range from DL0 to DL1 (interval indicated by A in FIGS. 3A to 3C), the electronic shutter speed is kept at 1/100 second. Within the A interval, the AGC gain of the analog AGC section 132 exhibits a first negative characteristic line CL1 along which it decreases linearly from the gain upper limit value AGCmax to “+0 dB”. In other words, within the A interval, the shutter value of 1/100 second is used and, when the light amount is small, the AGC gain is raised while the shutter speed is kept at 1/100 second so that the analog image pickup signal (that is, the A/D output) is kept at a fixed level as seen in FIG. 3B.

Within the interval A, since the shutter speed is fixed to 1/100 second, flickering can be prevented, and the brightness of the image can be kept fixed by analog AGC. Thus, the brightness of the image can be kept fixed as seen in FIG. 3C, and-appropriate light exposure control can be achieved.

The interval wherein the image pickup object illuminance is higher than DL1 originally is a region wherein, if it is tried to provide an appropriate luminance to the image, then the shutter speed should be set in an accumulation time shorter than 1/100 second. For example, when the image pickup object illuminance is just equal to DL1, in an ordinary case, the shutter speed is changed over to 1/200 second. However, in the present embodiment, the shutter speed is kept at 1/100 second. On the other hand, while the negative gain switches SW1 and SW2 are controlled, the digital AGC is rendered operative so that an appropriate image may be obtained.

For example, in the range of the image pickup object illuminance from DL1 to DL2 (in the interval indicated by a left half B1 of FIG. 3B), one of the negative gain switches SW1 and SW2 of the negative gain changeover section 214 is rendered active (on) so that the attenuation amount is corrected by gain control by the digital AGC section 212. In other words, within the interval B1, the digital AGC gain indicates a second negative characteristic line CL2 along which it decreases linearly from AGC1 to “+0 db”.

Within the interval B1, since the shutter speed is fixed to 1/100 second, flickering can be prevented. Further, as seen in FIG. 3B, although the analog image pickup signal (that is, the A/D output) rises, the luminance signal level can be decreased by an amount corresponding to the amount attenuated with the negative gain by the digital part. Further, the brightness of the image can be kept fixed as seen in FIG. 3C by the total gain of the negative gain and the digital AGC, and appropriate light exposure control can be achieved.

The value of AGC1 which is a digital AGC gain which corresponds to an apex of a rise of the digital AGC when the image pickup object illuminance is just equal to DL1 is set to a value with which the value of the photometry data DL at a point a, that is, when the shutter speed is 1/100 second and the negative gain is “+0 db” and the value of the photometry data DL at another point b, that is, when the gain of the digital AGC is AGC1 when the shutter speed is 1/100 second and one of the negative gain switches SW1 and SW2 is on become equal to each other. In the present example, since the gain when one of the negative gain switches SW1 and SW2 is on is “−6 dB”, the value of AGC1 is set to +6 dB.

Meanwhile, in the range of the image pickup object illuminance from DL2 to DL3 (in the interval indicated by a right half B2 of FIG. 3B), both of the negative gain switches SW1 and SW2 of the negative gain changeover section 214 are rendered active (on) so that the attenuation amount is corrected by gain control by the digital AGC section 212. In other words, within the interval B2, the digital AGC gain indicates a third negative characteristic line CL3 along which it decreases linearly from AGC2 to “+0 db”.

Also within the interval B2, since the shutter speed is fixed to 1/100 second, flickering can be prevented. Further, as seen in FIG. 3B, although the analog image pickup signal (that is, the A/D output) further rises, the luminance signal level can be decreased by an amount corresponding to the amount attenuated with the negative gain by the digital part. Further, the brightness of the image can be kept fixed as seen in FIG. 3C by the total gain of the negative gain and the digital AGC, and appropriate light exposure control can be achieved.

The value of AGC2 which is a digital AGC gain which corresponds to a peak of a rise of the digital AGC when the image pickup object illuminance is just equal to DL2 is set to a value with which the value of the photometry data DL at a point c, that is, when the shutter speed is 1/100 second and the negative gain is “−6 dB” and the value of the photometry data DL at another point d, that is, when the gain of the digital AGC is AGC2 when the shutter speed is 1/100 second and both of the negative gain switches SW1 and SW2 are on become equal to each other. In the present example, since the gain when both of the negative gain switches SW1 and SW2 are on is “−12 dB”, it means the value “−6 dB” is set by one of the negative gain switch, so the value of AGC2 is set to +6 dB. In other words, in the present example, the values of AGC1 and AGC2 are set to AGC1=AGC2.

In this manner, within the B interval, the shutter speed is fixed to 1/100 second to achieve a flickering-free state and the amount of a rise of the analog image pickup signal caused by the fixed shutter speed to 1/100 is lowered using a negative gain. Further, within the B interval, the screen luminance is kept fixed by rendering the digital AGC operative, that is, by stabilizing the output level of the digital image pickup signal by the total gain of the digital part.

The reason why, within the interval B (intervals B1 and B2), changeover control of the negative gain is not performed by the analog AGC but is performed by the digital part and the attenuation amount is compensated for using the digital AGC is that it is intended to prevent saturation of a signal and so forth in the preceding stage as far as possible. In other words, if the analog part takes charge of the entire AGC control, then an AGC loop must be formed such that a very wide dynamic range is assured, and actually, this is likely to give rise to a problem in terms of the saturation or the transient response.

It is to be noted that, where the configuration described above is employed, although the analog part (including the A/D conversion) need have a sufficient dynamic range, the AGC control can be suppressed to a low level (in the example described above, to +6 dB in the maximum), and stabilized light exposure control can be achieved.

The range of the image pickup object illuminance higher than DL3 (interval indicated by C in FIGS. 3A to 3C) is a region wherein the light amount is greater than that of the range within which the gain can be controlled by the negative gain switches SW1 and SW2 and the digital AGC. It is considered that the condition is in most cases met outdoors and no flickering occurs. Therefore, within the interval C, both of the negative gain switches SW1 and SW2 are rendered inactive (off; set back to +0 db) and light exposure control is performed with a high shutter speed of less than 1/100 second. Accordingly, within the interval C, the analog image pickup signal is stabilized by changeover to an arbitrary shutter speed (hereinafter referred to as shutter-free). By this, the brightness of the image can be kept fixed even if the AGC of the digital part is not rendered operative, and appropriate light exposure control can be achieved.

In short, the image pickup apparatus 10 operates with the shutter speed of 1/100 second in a state wherein the image pickup object illuminance is lower equal to or lower than DL3, but operates shutter-free in another state wherein the image pickup object illuminance is higher than DL3. Then, as the image pickup object illuminance increases from DL0 on the first negative characteristic line CL1, the analog AGC gain decreases linearly until it reduces to “+0 dB” at the image pickup object illuminance DL1, that is, at the a point. Within this period, the image luminance keeps a fixed value .through the automatic gain control (analog AGC).

Within the range of the image pickup object illuminance from DL1 to DL2 (within the B1 interval), the relationship between the image pickup object illuminance and the AGC gain is represented by the second negative characteristic line CL2, but within the range of the image pickup object illuminance from DL2 to DL3 (within the B2 interval), the relationship between the image pickup object illuminance and the AGC gain is represented by the third negative characteristic line CL3. Within the intervals B1 and B2 (interval B), the image luminance keeps a fixed value through the automatic gain control (digital AGC) of the digital part. Further, within the range of the image pickup object illuminance higher than DL3 (within the interval C), the image luminance keeps a fixed value by shutter-free control.

According to conventional light exposure control for a flicker-free condition, if the image pickup object illuminance exceeds DL1 even a little along the first negative characteristic line CL1, then the AGC gain (by both of the analog and digital parts) is fixed to “+0 dB”, and therefore, the image luminance begins to increase until the image is saturated as seen in FIG. 3B.

However, according to the light exposure control of the embodiment described above, when the AGC gain decreases along the first negative characteristic line CL1 until it becomes equal to “+0 dB”, the AGC gain control of the digital part is changed over. In particular, when the image pickup object illuminance reaches DL1 (the first negative gain changeover point), the negative gain changeover section 214 sets a predetermined negative gain (in the example described above, −6 dB), and the gain amount of the digital AGC section 212 is raised at a stroke to-the gain AGC1, that is, from the a point to the b point so as to compensate for the negative gain.

When the image pickup object illuminance increases further than DL1, the digital AGC gain now decreases along the second negative characteristic line CL2 from AGC1 toward “+0 db”. In short, the state wherein the automatic gain control remains effective to keep the image luminance fixed continues toward the higher illuminance side as seen from FIG. 3C.

Further, when the digital AGC gain decreases along the second negative characteristic line CL2 within the range of the image pickup object illuminance from DL1 to DL2 until it becomes equal to DL2, the negative gain of the digital part is further changed over. In particular, when the image pickup object illuminance reaches DL2 (the second negative gain changeover point), the negative gain changeover section 214 increases the negative gain by one more stage (in the example described above, set to totaling −12 dB), and the gain amount of the digital AGC section 212 is raised at a stroke to the gain AGC2, that is, from the c point to the d point, so that the increased amount of the negative gain may be compensated for.

Then, when the image pickup object illuminance increases further than DL2, the digital AGC gain now decreases along the third negative characteristic line CL3 from AGC2 toward “+0 db”. In other words, the state wherein the automatic gain control remains effective to keep the image luminance fixed continues to the further higher illuminance side.

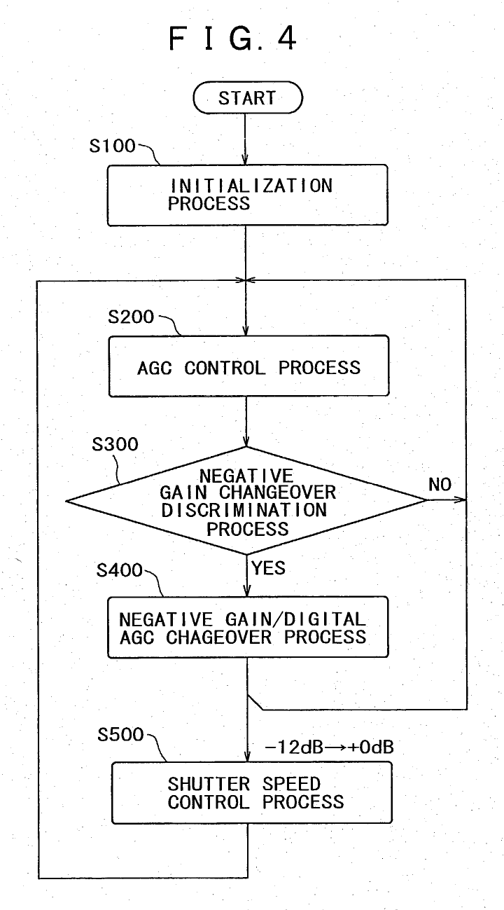

FIG. 4 illustrates a main process in a processing procedure of the light exposure control by the light exposure control section 260. The main process includes an initialization process (S100), an AGC control process (S200), a negative gain changeover discrimination process (S300), a negative gain/digital AGC changeover process (S400), and a shutter speed control process (S500).

In the initialization process (S100), for example, an initial shutter speed is determined in response to connection of the power supply. In the AGC control process (S200), the gain control signal GC and the electronic shutter control signal SC are controlled so that the photometry data DL from the photometry section 250 may fall within a convergence range. In the negative gain changeover discrimination process (S300), it is discriminated whether or not the relationship between the shutter speed and the AGC gain satisfies a requirement for negative gain changeover. In the negative gain/digital AGC changeover process (S400), the negative gain changeover section 214 is changed over to a mode of a predetermined negative gain (in the example described hereinabove, one of +0 db, −6 dB and −12 dB). In the shutter speed control process (S500), when the negative gain changeover section 214 is changed over from “−12 dB” mode to the “+0 db” mode, the negative gain changeover section 214 is changed over to a shutter-free mode wherein the electronic shutter speed is changed over to control the light exposure amount.

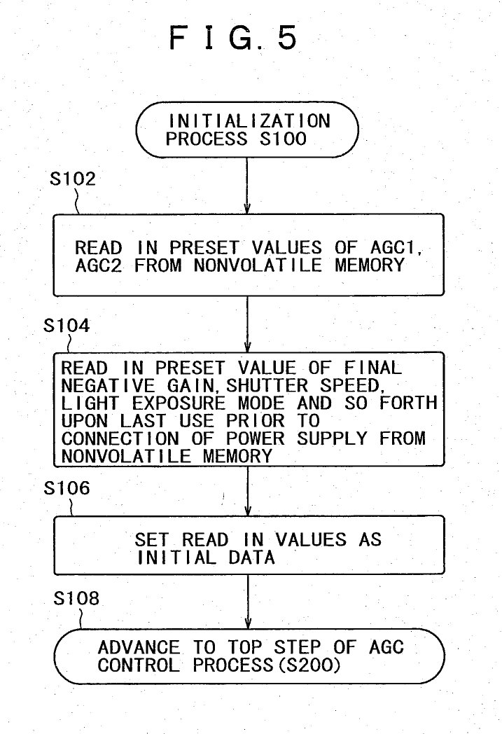

FIG. 5 illustrates a particular example of the initialization process (S100). Referring to FIG. 5, the light exposure control section 260 first reads in an AGC gain (AGC1) of a correction amount at the first negative gain changeover point and another AGC gain (AGC2) of another correction amount at the second negative gain changeover point from a nonvolatile memory not shown and stores them into a predetermined address of a RAM not shown service as a main memory (S102). The values of AGC1 and AGC2 are determined in accordance with changeover set values of the negative gain to the negative gain changeover section 214 as described hereinabove.

Then, the light exposure control section 260 reads in a final negative gain set value, a final shutter speed, a final light exposure mode and so forth in the last use before the power supply is connected from the nonvolatile memory (S104) and places the final negative gain set value, shutter speed and so forth in the last use into a shutter speed variable SS set in the RAM of the main memory 9 as initial data (S106). Thereafter, the processing advances to the top step of the AGC control process (S200) (S108).

The use of the initialization process (S100) is effective where, typically because the image pickup apparatus 10 is located at a fixed place, the conditions in the last use and the conditions in the current use are similar to each other and the illuminance variation around the image pickup apparatus 10 is comparatively small. It is not necessary, for example, to measure the ambient illuminance and arithmetically operate an appropriate shutter speed in accordance with the illuminance every time the power supply is connected, and setting of an initial value for the shutter speed can be performed rapidly.

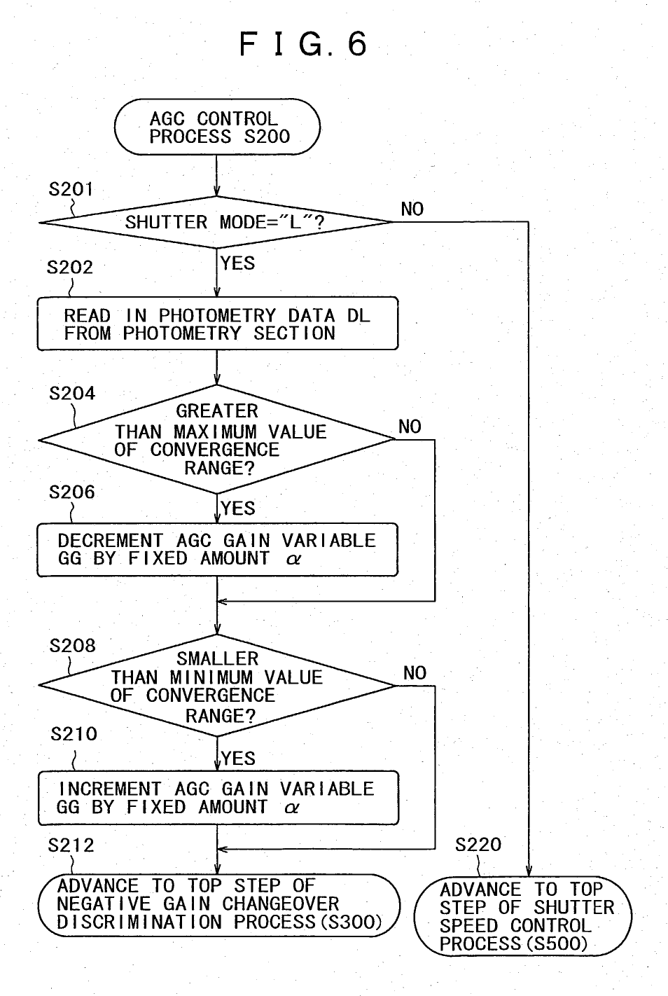

FIG. 6 illustrates a particular example of the AGC control process (S200). Referring to FIG. 6, the light exposure control section 260 first discriminates whether or not the shutter mode is set to “L” (S201). If the shutter mode is set to any other than “L” (that is, set to “H”) (NO at step S201), then the processing advances to the top step of the shutter speed control process (S500) (S220).

On the other hand, when the shutter mode is “L” (YES at step S201), the light exposure control section 260 reads in photometry data DL from the photometry section 250 (S202) and discriminates whether or not the value of the photometry data DL is higher than the maximum value of the convergence range (S204) If the value of the photometry data DL is not higher than the maximum value (NO at step S204), then the light exposure control section 260 immediately discriminates whether or not the value of the photometry data DL is lower than the minimum value of the convergence range (S208). On the other hand, if the value of the photometry data DL is higher than the maximum value (YES at step S204), then the light exposure control section 260 decrements the AGC gain variable GG to be set to the RAM of the main memory by a fixed amount α (S206) so that the gain (gain value) of the digital AGC may be decreased, and then discriminates whether or not the value of the photometry data DL is smaller than the minimum value of the convergence range (S208).

If the value of the photometry data DL is equal to or higher than the minimum value (NO at step S208), then the light exposure control section 260 immediately ends the AGC control process and advances the processing to the top step of the negative gain changeover discrimination process (S300) (S212). On the other hand, if the value of the photometry data DL is lower than the minimum value (YES at step S208), then the light exposure control section 260 increments the AGC gain variable GG by the fixed amount a (S210) so that the gain (gain value) of the digital AGC may be increased, and then advances the processing to the top step of the negative gain changeover discrimination process (S300) (S212).

As the AGC control process (S200) is repeated (the processing returns to the AGC control process (S200) from the negative gain changeover discrimination process hereinafter described), the value of the photometry data DL converges into a convergence range defined by the minimum value and the maximum value. In particular, the gain of the digital AGC is controlled along the second negative characteristic line CL2 or the third negative characteristic line CL3 in FIG. 3A, and the image luminance is kept at a fixed value in FIG. 3C.

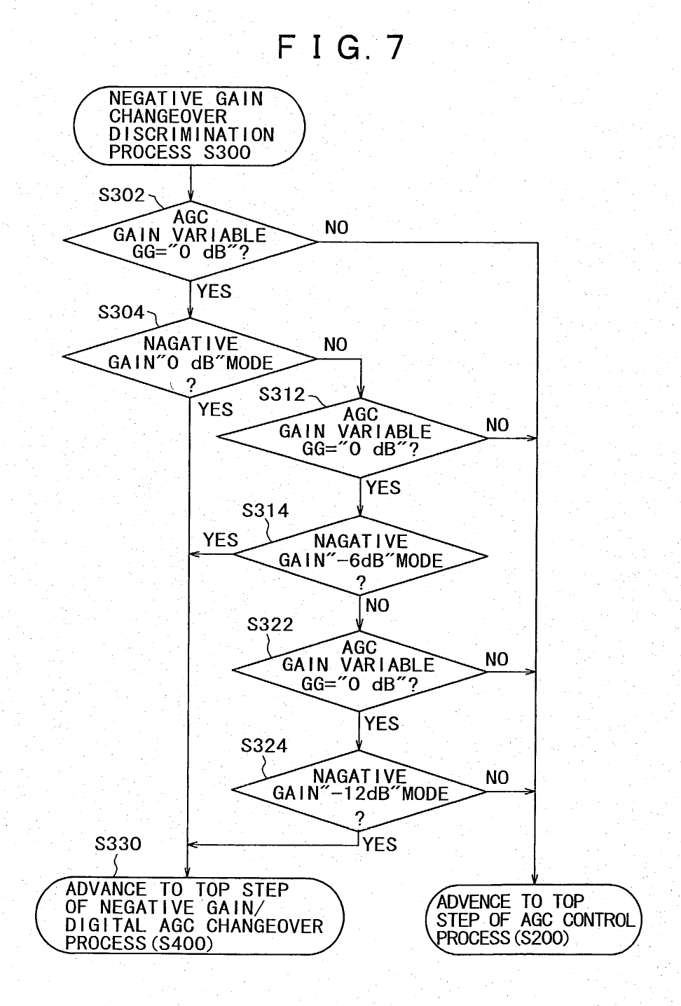

FIG. 7 illustrates a particular example of the negative gain changeover discrimination process (S300). Referring to FIG. 7, the light exposure control section 260 first discriminates whether or not the value set to the AGC gain variable GG is “0 db” (S302). If the value is “0 db” (YES at step S302), then the light exposure control section 260 discriminates whether or not the negative gain changeover section 214 is in the “0 db” mode (S304). If the negative gain changeover section 214 is in the “0 db” mode (YES at step S304), then the processing advances to the top step of the negative gain/digital AGC changeover process (S400) (S330).

Thus, if the discriminations at both of steps S302 and S304 are in the affirmative, then this signifies that the AGC gain variable GG is “0 db” and the negative gain changeover section 214 is in the “0 db” mode (hereinafter referred to as first case), and this corresponds to the fact that the gain decreases along the first negative characteristic line CL1 in FIG. 3A until it reaches the a point. At this time, in order to change over the negative gain changeover section 214 to the “−6 dB” mode, the processing advances to the negative gain/digital AGC changeover process (S400) (S330).

On the other hand, if the discrimination at step S304 is in the negative (NO at step S304), then the light exposure control section 260 discriminates whether or not the value set to the AGC gain variable GG is “0 db” (S312). If the value is “0 db” (YES at step S312), then the light exposure control section 260 discriminates whether or not the negative gain changeover section 214 is in the “−6 dB” mode (S314). If the negative gain changeover section 214 is in the “−6 dB” mode (YES at step S314), then the processing advances to the top step of the negative gain/digital AGC changeover process (S400).

This signifies that the AGC gain variable GG is “0 dB” and the negative gain changeover section 214 is in the “−6 dB” mode (hereinafter referred to as second case), and this corresponds to the fact that the gain decreases along the second negative characteristic line CL2 in FIG. 3A until it reaches the c point. At this time, in order to change over the negative gain changeover section 214 to the “−12 dB” mode, the processing advances to the negative gain/digital AGC changeover process (S400).

On the other hand, if the discrimination at step S314 is in the negative (NO at step S314), then the light exposure control section 260 discriminates whether or not the value set to the AGC gain variable GG is “0 db” (S322). If the value is “0 db” (YES at step S322), then the light exposure control section 260 discriminates whether or not the negative gain changeover section 214 is in the “−12 dB” mode (S324). If the negative gain changeover section 214 is in the “−12 dB” mode (YES at step S324), then the processing advances to the top step of the negative gain/digital AGC changeover process (S400) (S330).

This signifies that the AGC gain variable GG is “0 dB” and the negative gain changeover section 214 is in the “−12 dB” mode (hereinafter referred to as third case) and this corresponds to the fact that the gain decreases along the third negative characteristic line CL3 in FIG. 3A until it reaches the e point. At this time, in order to change over the negative gain changeover section 214 (back) to the “+0 db” mode, the processing advances to the negative gain/digital AGC changeover process (S400).

When the discrimination at step S302, 312, 322 or 324 is in the negative, the processing advances (returns) to the top step of the AGC control process (S200) (S340). In other words, changeover of the minus gain is not performed except the three first to third cases described above.

It is to be noted that the steps S312 and S322 for discrimination of whether or not the AGC gain variable GG is set to “0 db” need not actually be provided but can be omitted. This is because, when the discrimination at step S304 is in the negative, the AGC gain variable GG is “0 dB”.

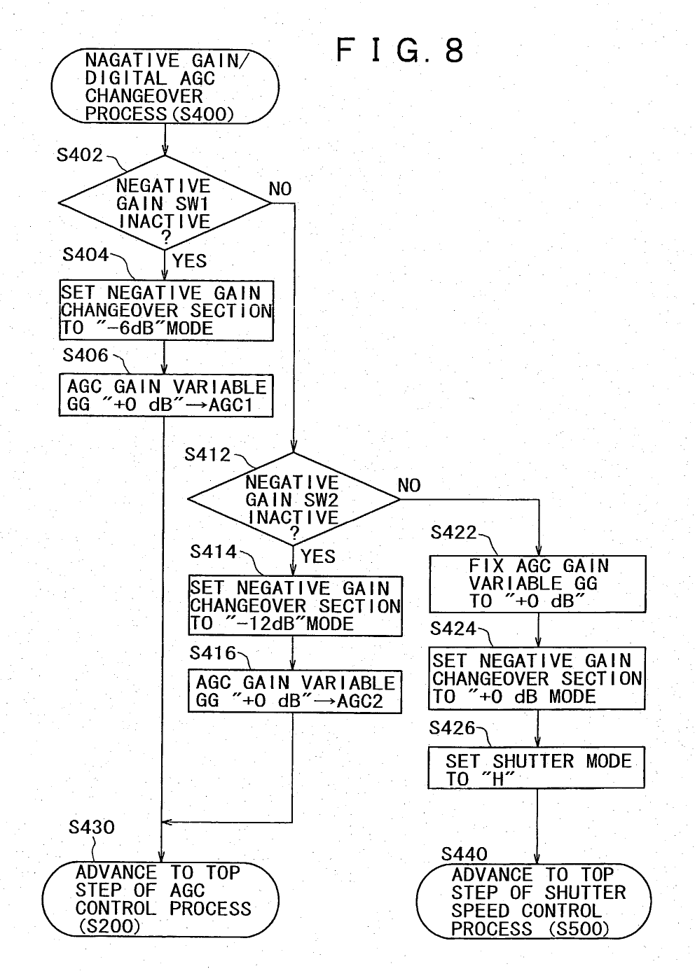

FIG. 8 illustrates a particular example of the negative gain/digital AGC changeover process (S400). Referring to FIG. 8, the light exposure control section 260 first discriminates whether or not a command of the gain control signal GC2 corresponding to the negative gain switch SW1 is set inactive (S402). If the command is inactive (YES at step S402), then the light exposure control section 260 changes over the command corresponding to the negative gain switch SW1 to active thereby to set the negative gain changeover section 214 to the “−6 dB” mode (S404).

Further, in order to compensate for a decrease of the gain which arises from the changeover, the light exposure control section 260 changes the setting of the AGC gain variable GG representative of the gain set value to the digital AGC section 212 from “+0 db” to AGC1 (in the present example, “+6 dB”) (S406). In the present embodiment, in accordance with the change setting, the digital AGC section 212 shifts the digital data leftwardly (toward the MSB side) by one bit to double (×2; +6 dB) the digital data. In other words, the changed amount of the negative gain is compensated for by bit shifting similarly as in the changeover of the attenuation degree by the negative gain changeover section 214.

On the other hand, if the discrimination at step S402 is in the negative, then the light exposure control section 260 discriminates whether or not the command of the gain control signal GC2 corresponding to the negative gain switch SW2 is set inactive (S412). If the command is inactive (YES at step S412), then the light exposure control section 260 renders also the command corresponding to the negative gain switch SW2 (that is, both of the negative gain switches SW1 and SW2) active thereby to set the negative gain changeover section 214 to the “−12 dB” mode (S414).

Further, in order to compensate for a decrease of the gain which arises from the mode changeover, the light exposure control section 260 changes the gain set value to the digital AGC section 212 from “+0 db” to AGC2 (in the present example, “+6 dB”) (S416). In the present embodiment, in accordance with the change, the digital AGC section 212 shifts the digital data leftwardly (toward the MSB side) by one bit to double (×2; +6 dB) the digital data.

After the AGC gain variable GG is changed (S406 or S416), in any case, the light exposure control section 260 places the currently set value of the AGC gain variable GG into a predetermined address of the nonvolatile memory and then returns the processing to the top step of the AGC control process (S200) (S430).

On the other hand, if the discrimination at step S412 is in the negative and the negative gain changeover section 214 is set to the “−12 dB” mode, then the light exposure control section 260 fixes the AGC gain variable GG to “0 db” (S422) and renders the commands of the gain control signal GC2 corresponding to both of the negative gain switches SW1 and SW2 inactive thereby to set the negative gain changeover section 214 to the “+0 dB” mode (S424). Further, in order to change over the electronic shutter speed to the shutter-free mode, the light exposure control section 260 sets the shutter mode to “H” and stores the currently set value of the AGC gain variable GG and the value of the mode into a predetermined address of the nonvolatile memory, and then advances the processing to the top steep of the shutter speed control process (S500) (S440).

The process at step S404 or S406 corresponds to the fact that the negative gain changeover section 214 is placed into the “−6 dB” mode at the first negative gain changeover point (a point or b point) and the digital AGC gain is changed over from 0 db (the a point) to AGC1 (the b point) in FIG. 3A. Similarly, the process at step S414 or S416 corresponds to the fact that the negative gain changeover section 214 is placed into the “−12 dB” mode at the second negative gain changeover point (c point or d point) and the digital AGC gain is changed over from 0 dB (the c point) to AGC2 (the b point). Further, the process at step S422, S424 or S426 corresponds to the fact that the negative gain changeover section 214 is placed back into the “+0 db” mode at the third negative gain changeover point (e point) and the digital AGC gain is stopped so that shutter-free light exposure control may thereafter be performed.

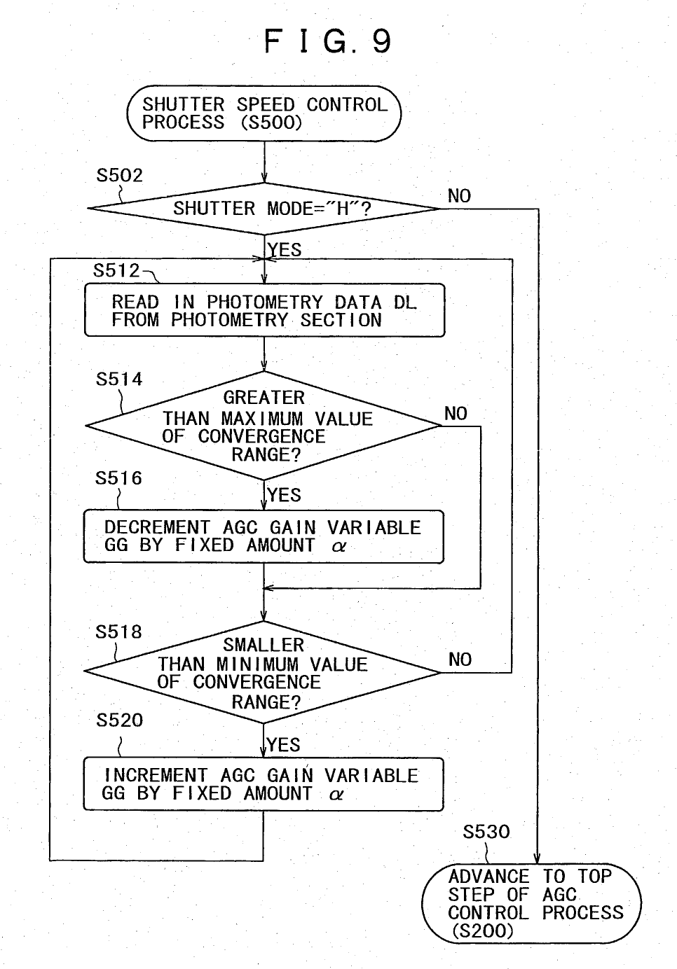

FIG. 9 illustrates a particular example of the shutter speed control process (S500). Referring to FIG. 9, the light exposure control section 260 first discriminates whether or not the shutter mode is set to “H” (S502). If the shutter mode is any other than “H” (that is, “L”) (NO at step S502), then the processing advances to the top step of the AGC control process (S200) (S504).

On the other hand, if the shutter mode is “H” (YES at step S502), then the light exposure control section 260 controls, while supervising the photometry data DL, the electronic shutter control signal SC so that the photometry data DL may converge into the predetermined range thereby to control the timing at which the shutter pulse XSUB should be generated from the timing signal production section 200.

In particular, the light exposure control section 260 first reads in the photometry data DL from the photometry section 250 (S512) and discriminates whether or not the value of the photometry data DL is higher than the maximum value of the convergence range (S514). If the value of the photometry data DL is equal to or lower than the maximum value (NO at step S514), then the light exposure control section 260 immediately discriminates whether or not the value of the photometry data DL is lower than the minimum value of the convergence range (S518). On the other hand, if the value of the photometry data DL is higher than the maximum value (YES at step S514), then the light exposure control section 260 decrements the shutter speed variable SS to be set to the RAM of the main memory by a fixed amount β so that the electronic shutter speed may be raised (S516), and then discriminates whether or not the value of the photometry data DL is lower than the minimum value of the convergence range (S518).

If the value of the photometry data DL is equal to or higher than the minimum value (NO at step S518), then the light exposure control section 260 immediately returns the processing to step S512 so that the photometry data DL may be read in from the photometry section 250 again. On the other hand, if the value of the photometry data DL is lower than the minimum value (YES at step S518), then the light exposure control section 260 increments the shutter speed variable SS by the fixed amount β so that the shutter speed may be lowered (S520) and then returns the processing to step S512 so that the photometry data DL may be read in again.

In short, the timing control of the shutter pulse XSUB is performed so that the electronic shutter speed may be increased when the photometry data DL is higher than the convergence range but the electronic shutter speed may be decreased when the photometry data DL is lower than the convergence range thereby to control the light exposure time of the image pickup device 12 through the driving section 15.

As the changeover of the shutter speed (at steps S512 to S520) is repeated, the value of the photometry data DL converges into the convergence range defined by the minimum value and the maximum value. In short, within the C interval of FIG. 3A, light exposure control is executed at a high shutter speed of less than 1/100 second, and an image pickup signal of a fixed level determined as the convergence range is always obtained automatically and the image luminance is kept at the fixed value in FIG. 3C.

It is to be noted that the steps S312 and S322 for the discrimination of whether or not the AGC gain variable GG is set to “0 db” are not required actually but may be omitted. This is because, when the discrimination at step S304 is in the negative, the AGC gain variable GG is “0 db”.

It is to be noted that, while the foregoing description of the particular examples of the processes is directed to a process in the direction in which the image pickup object illuminance gradually increases, also where a process in the opposite direction is performed, the basic process is similar to that described above. However, such modification that, in the discrimination process for a changeover point of the negative gain, it is used as a criterion that the preset values AGC1 and AGC2 for the AGC gain variable GG are at a changeover point of the negative gain (in the present example, “+6 dB”). Further, at such changeover points, hunting may possibly occur although it is not so considerable as in the analog AGC. In this instance, for example, a control method which uses a hysteresis may be adopted to prevent such hunting.

As described above, with the light exposure control of the first embodiment, since AGC control and shutter speed changeover are combined and, where the illuminance is within a predetermined range (DL1 to DL3), they are further combined with negative gain setting, the light exposure amount can be controlled so as to keep the brightness of the image fixed without suffering from flickering or saturation over a wide range of the illuminance. In short, the dynamic range of the automatic gain control function for stabilizing the image luminance with respect to the image pickup object illuminance can be expanded.

For example, even if an image is picked up while the accumulation time of the shutter is kept synchronized with the period (blinking period) of the light emission characteristic of the fluorescent lamp, an image of an appropriate light amount can be outputted without suffering from saturation. Further, when an image is picked up within a room under a fluorescent lamp, even if the image includes a bright portion, occurrence of flickering can be prevented.

Further, since negative gain setting can be performed by bit shifting, the negative gain switches SW1 and SW2 can be added by comparatively easy modification to the circuit. In addition, since the timing signal production section 200, photometry section 250 and light exposure control section 260 can be obtained by small modification to conventional ones, circuit modification or modification to a control algorithm can be performed comparatively readily for the entire light exposure control function.

Furthermore, since the light exposure control is performed automatically, manual changeover of the shutter speed or the negative gain is unnecessary, and the operability is good in that the user need not perform such operation.

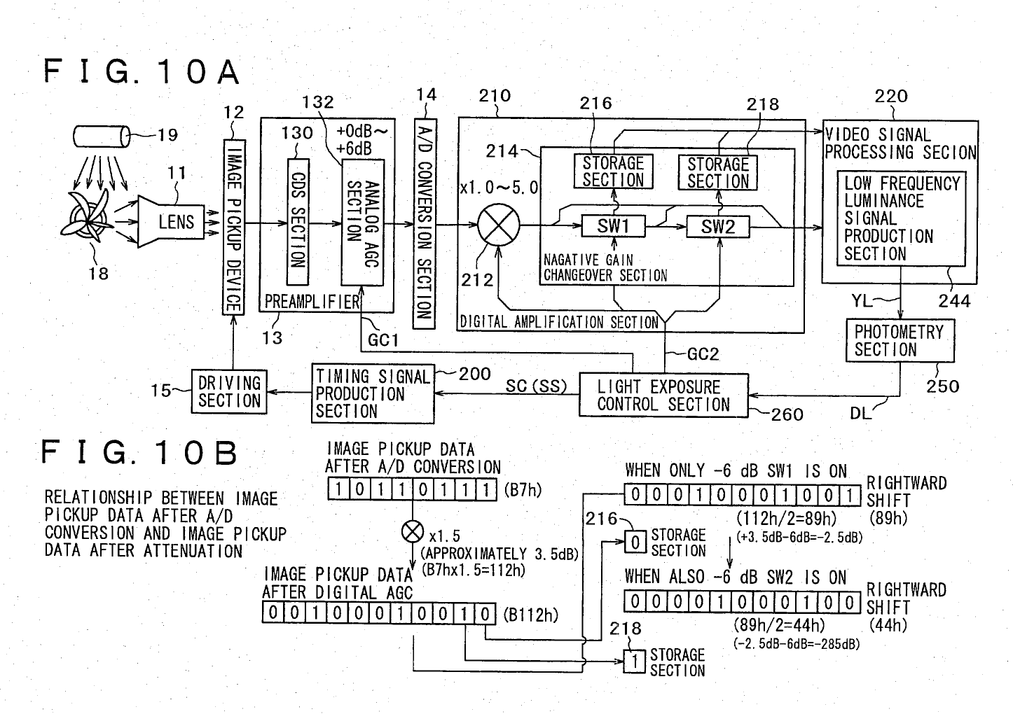

FIG. 10A shows another image pickup apparatus to which the present invention is applied and particularly shows functional blocks of a light exposure control function, and FIG. 10B illustrates a relationship between image pickup data immediately after A/D conversion and image data processed by a digital amplification section. In FIG. 10B, image pickup data outputted from an A/D conversion section is “B7h” similarly to that illustrated in FIG. 2B.

In the image pickup apparatus of the first embodiment, when the negative gain changeover section 214 is set to the “−6 dB” or “−12 dB” mode, data for 1 bit or 2 bits on the LSB side of the digital data is lost by bit shifting of the digital data. Although the difference of the information lost by the bit shifting (the absolute amount of the lost information) is small, such loss of data is disadvantageous against a request for obtainment of, for example, an image of a high sharpness in that fine information acquired in the analog part is lost.

Thus, the image pickup apparatus 10 of the second embodiment is a modification to but is different from the image pickup apparatus 10 of the first embodiment in that the digital amplification section 210 thereof includes a pair of storage sections 216 and 218 for retaining data to be lost by bit shifting by the negative gain changeover section 214 and, when the negative gain changeover section 214 is set to the “−6 dB” or “−12 dB” mode, information lost by bit shifting of digital data can be used by the video signal processing section 220.

If the negative gain changeover section 214 is set to the “+0 db” mode as seen in FIG. 10B, then since bit shifting is not performed, the negative gain changeover section 214 clears the storage section 216 for the LSB0 and the storage section 218 for the LSB1. Consequently, lost data of “0; zero” is outputted from both of the storage sections 216 and 218.

Then, if the negative gain changeover section 214 is set to the “−6 dB” mode, then it sets the value of the LSB0 of input data to the storage section 216 for the LSB0. In the present example, lost data of “0; zero” is outputted from the storage section 216.

On the other hand, if the negative gain changeover section 214 is set to the “−12 dB” mode, then it sets the value of the LSB1 of input data to the storage section 218 for the LSB1. In the present example, lost data of “1” is outputted from the storage section 218. Here, the data retained in each of the storage sections 216 and 218 is considered to be a discrimination flag representative of whether or not the effective data “1” is present in the LSB0 or the LSB1.

The video signal processing section 220 performs a predetermined process using information retained in the storage section 216 or storage sections 216 and 218. For example, when a rounding process (round-down/round-up) is performed in a processing procedure, if the information retained in the storage section 216 or 218 is “1”, then a rounding process is corrected so that the lost information may be reflected on the processed data. For example, information which should normally be rounded down is rounded up.

Consequently, even if the negative gain changeover section 214 is set to the “−6 dB” or “−12 dB” mode, for example, white balance control of a high degree of accuracy can be achieved or an image of a high resolution can be obtained.

It is to be noted that, although the variation frequency of information lost by bit shifting is not univocal, the absolute amount of it is very small and it is considered that it has a high degree of influence principally on the luminance signal YH which includes a comparatively high frequency component. Accordingly, only the high frequency luminance signal production section 242 may execute a process in which information remained in the storage sections 216 and 218 is used.

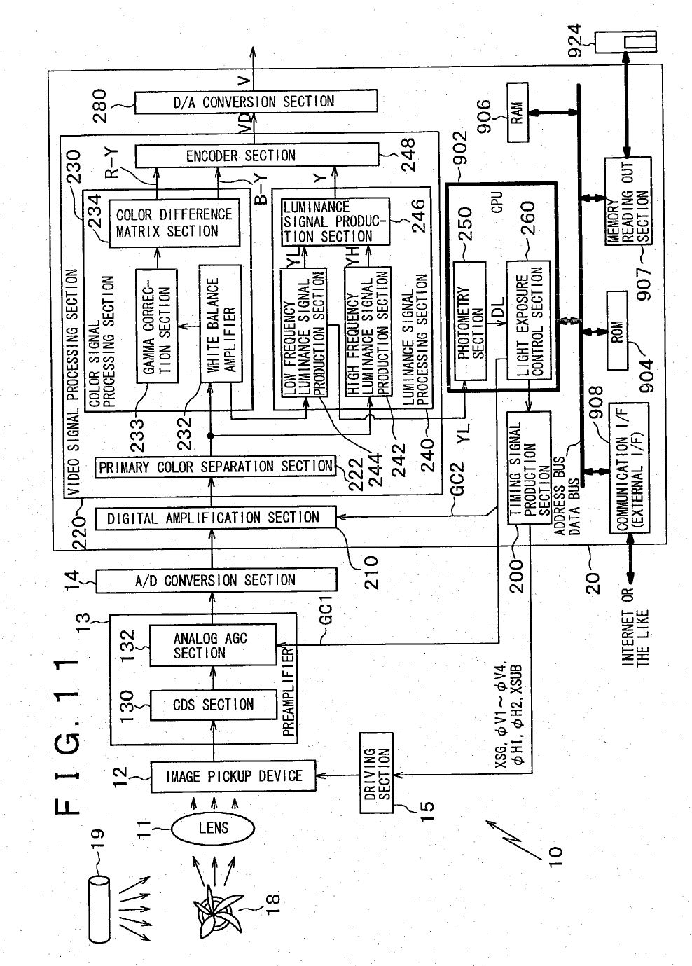

FIG. 11 shows a further image pickup apparatus to which the present invention is applied. The image pickup apparatus 10 of the present embodiment is a modification to but is different from the image pickup apparatus 10 of the first or second embodiment in that a recording medium such as a memory card can be removably loaded and that it can be connected to a communication network such as the Internet.

In particular, referring to FIG. 11, the image pickup apparatus 10 of the third embodiment includes, in addition to the components of the first or second embodiment, a CPU 902, a ROM (Read Only Memory) 904, a RAM 906, a memory reading out section 907, and a communication interface (I/F) 908. A recording medium 924 is used for registration of, for example, program data for causing the CPU 902 to perform software processing and data of the conversion range of photometry data DL, a set value of the negative gain by the negative gain changeover section 214 and so forth. The memory reading out section 907 stores (installs) data read out from the recording medium 924 into the RAM 906. The communication interface 908 mediates transfer of communication data to and from the communication network such as the Internet.

The image pickup apparatus 10 having such a configuration as described above is basically similar in configuration and operation to the image pickup apparatus 10 described hereinabove as the first or second embodiment. Further, a program for causing a computer to execute such a process as described above is distributed through a recording medium 924 such as a flash memory, an IC card or a nonvolatile semiconductor memory card such as a miniature card. Alternatively, the program may be acquired or updated through downloading from a server through a communication network such as the Internet.

Into a semiconductor memory such as an IC card or a miniature card as an example of the recording medium 924, some or all of the functions of the process of the image pickup apparatus 10 (particularly of the main part, the photometry section 250 and/or the light exposure control section 260) described hereinabove in connection with the embodiments may be stored. Accordingly, programs or storage media in which such programs are stored can be provided. For example, a program for the photometry section, that is, software which may be installed into the RAM 906 or the like, includes functioning sections for screen division photometry, luminance peak detection, integrated data outputting and so forth similarly to the photometry section 250 described hereinabove in connection with the embodiments.

Similarly, a program for the light exposure control section, that is, software to be installed into the RAM 906 or the like includes functioning sections for receiving photometry data DL from a functioning section as the photometry section, issuing an electronic shutter control signal SC to the timing signal production section 200 or controlling the AGC gain variable GG for the digital AGC section 212 so that the photometry data DL may be kept at a fixed level and no flickering may occur even under the illumination by a fluorescent lamp, setting the negative gain changeover section 214 to the negative gain mode when the illuminance has a predetermined level and so forth similarly to the light exposure control section 260 described hereinabove in connection with the embodiments.

Thus, the memory reading out section 907 reads program data or data of the convergence range of the photometry data DL from the recording medium 924 and passes the data to the CPU 902. Then, the software is installed from the recording medium 924 into the RAM 906. It is to be noted that part of the program data or part of the data of the convergence range and so forth may be installed in the ROM 904. The RAM 906 stores various data or programs read out by the memory reading out section 907 or data produced through execution of a program by the CPU 902, and reads the stored data or programs and passes them to the CPU 902.

The software is executed by the CPU 902 after it is read out into the RAM 906. For example, the CPU 902 can execute the light exposure control process described hereinabove based on the programs stored in the ROM 904 which is an example of a recording medium and the RAM 906 to implement the functions for executing the process described above through the software. In other words, the light exposure control process can be implemented by digital signal processing using a computer. In each of such recording media 924, data of the convergence range of the photometry data DL or negative gain set values suitable for each user and programs which describe a suitable light exposure control process based on such data can be retained without being influenced by set contents of any other user.

By this, for example, data of the convergence range of the photometry data DL or the negative gain set value and a suitable light exposure control process based on such data can be set suitably in accordance with specifications of each user. Further, a process in accordance with specifications of each user can be switchably used only by exchanging the recording medium 924.

While the present invention has been described in connection with some preferred embodiments, the technical scope of the present invention shall not be restricted by the particulars of the embodiments described above. Various alterations or modifications to the embodiments described above are possible, and also such altered or modified forms are included in the technical scope of the present invention. Further, the embodiments described above do not restrict the invention as set forth in claims, and all of combinations of the features described in the embodiments are not necessarily essential to the solution of the invention.

For example, while, in the embodiments described above, only −6 dB and −12 dB can be set as the negative gain set value so that a negative gain may be set only by. bit shifting, any arbitrary value may be set as the negative gain set value. In this instance, however, an arithmetic operation circuit for such set values is required, and this requires an increased circuit scale.

Further, while, in the embodiments described above, the digital part is used to change over the negative gain, alternatively the analog part may execute such changeover as described hereinabove. Further, the digital AGC section 212 and the negative gain changeover section 214 may be arranged in the reverse order, that is, the digital AGC section 212 may be arranged in the next stage to the negative gain changeover section 214. Furthermore, the portion of the image pickup apparatus 10 other than the photometry section 250 and the light exposure control section 260 may have a configuration different from that of the embodiments described hereinabove.

Further, the image pickup apparatus 10 may further include, for example, a flickering detection section and execute light exposure control wherein the electronic shutter speed is set so as to be synchronized with the blinking period of the light source only when flickering is detected. If a combination of, for example, a fluorescent lamp which emits light in 100 Hz and an image pickup device which performs a light exposure operation in 60 Hz is taken as an example, then three different light exposure periods are involved, and flickering arises from a difference in the level of the image pickup signal from the image pickup device among the three different light exposure periods.

Therefore, as a flickering detection method, for example, a luminance integrated value for one screen is inputted for every VD at a timing of a vertical synchronizing signal and level comparison between such integrated values is performed for every VD to detect a peak pattern after every 3 VDs, and if the detection number of such peak patterns exceeds a predetermined probability in a predetermined period, it is determined that flickering occurs. Further, while flicking caused by a relationship between the blinking period of a fluorescent lamp and the light exposure period of an image pickup device is described in the foregoing description of the embodiments, the light source is not limited to a fluorescent lamp.

The present invention is not limited to the details of the above described preferred embodiments. The scope of the invention is defined by the appended claims and all changes and modifications as fall within the equivalence of the scope of the claims are therefore to be embraced by the invention.

What is claimed is:

1. A light exposure control method, comprising the steps of:
acquiring photometry data based on an image pickup signal from an image pickup device and picking up an image of an image pickup object while a gain value of a predetermined image signal based on the image pickup signal is controlled within a positive range so that the photometry data may be kept substantially fixed and a shutter speed of an electronic shutter of said image pickup device is synchronized with a period of blinking of a light source so that a flickering component originating from the blinking of said light source may be suppressed; and
changing over the gain value of the image signal to a negative gain when an illuminance of the image pickup object acquired based on three different kinds of information including the gain value set for the image signal, the shutter speed set so as to be synchronized with the period of the blinking of said light source and the photometry data satisfy a condition determined in advance.

2. A light exposure control method according to claim 1, wherein the negative gain is set so that the magnitude of the image signal based on the image pickup signal acquired with the set shutter speed of said image pickup device and having the adjusted gain value may be smaller than that prior to the adjustment of the gain value.

3. A light exposure control method according to claim 1, wherein the image produced based on the predetermined image signal is corrected using a lost signal component which is lost when the gain value of the image signal is set to a negative gain.

4. A light exposure control circuit, comprising:
a gain control section for controlling, based on photometry data acquired based on an image pickup signal from an image pickup device, a gain value of a predetermined image signal based on the image pickup signal so that the photometry data may be kept substantially fixed and a flickering component originating from blinking of a light source may be suppressed;
a shutter speed setting section for changing over a shutter speed of an electronic shutter of said image pickup device; and
a light exposure control section for determining a combination of a gain value to be set to said gain control section and a shutter speed to be set to said shutter speed setting section with which the flickering component originating from the blinking of said light source can be suppressed and issuing an instruction of a negative gain value to said gain control section when an illuminance of an image pickup object acquired based on three different kinds of information including the gain value set to said gain control section, the shutter speed set to said shutter speed setting section and synchronized with the blinking of said light source and the photometry data acquired based on the image pickup signal satisfies a condition determined in advance.

5. A light exposure control circuit according to claim 4, further comprising a photometry section for acquiring photometry data based on the image pickup signal from said image pickup device.

6. An image pickup apparatus for picking up an image of an image pickup object illuminated by a light source, comprising:
an image pickup device including an electronic shutter having an adjustable shutter speed;
an image signal processing section for producing an image based on an image pickup signal from said image pickup device;
a photometry section for acquiring photometry data based on the image pickup signal from said image pickup device;
a gain control section for controlling a gain value of a predetermined image signal based on the image pickup signal;
a shutter speed setting section for changing over the shutter speed of said electronic shutter of said image pickup device; and
a light exposure control section for determining, based on the photometry data acquired by said photometry section, a combination of a gain value for said gain control section with which the photometry data can be kept substantially fixed and a flickering component originating from blinking of said light source can be suppressed and a shutter speed with which the flickering component originating from the blinking of said light source can be suppressed and for issuing an instruction to said shutter speed setting section to change over the shutter speed to the determined shutter speed and notifying said gain control section of the determined gain value;
said light exposure control section issuing an instruction of a negative gain value to said gain control section when an illuminance of an image pickup object acquired based on three different kinds of information including the gain value set to said gain control section, the shutter speed set to said shutter speed setting section and synchronized with the blinking of said light source and the photometry data acquired by said photometry section satisfies a condition determined in advance.

7. An image pickup apparatus according to claim 6, wherein said gain control section includes a first gain control section capable of adjusting the gain amount arbitrarily at least within a positive range and a second gain control section for setting the gain amount to a fixed negative gain determined in advance, and said light exposure control section determines the gain value such that a sum total of the positive gain to be set to said first gain control section and the fixed negative gain to be set to said second gain control section has the negative gain value.

8. An image pickup apparatus according to claim 7, wherein said light exposure control section sets, substantially in an instant when the fixed negative gain is set to said second gain control section, a positive gain sufficient to compensate for the fixed negative gain to said first gain control section.

9. An image pickup apparatus according to claim 7, further comprising an analog to digital conversion section for converting an analog image pickup signal from said image pickup device into digital data, and wherein said first and second gain control sections change over a gain of the digital data outputted from said analog to digital conversion section.

10. An image pickup apparatus according to claim 9, wherein said light exposure control section determines the gain value to be set to said first gain control section so as to compensate for a rise of the analog image pickup signal caused by a rise of the illuminance of the image pickup object under the condition that said second gain control section sets the gain value to the fixed negative gain.

11. An image pickup apparatus according to claim 6, further comprising a storage section for storing a lost signal component which is lost when said gain control section sets the gain value to the negative gain, and wherein said image signal processing section corrects the image produced based on the predetermined image signal using the lost signal component stored in said storage section.

12. An image pickup apparatus according to claim 6, wherein said light exposure control section sets a shutter speed equal to twice a frequency of a power supply which drives said light source to said shutter speed setting section.

13. A program for causing a computer to execute a light exposure control process for adjusting a shutter speed of an image pickup device and a gain of an image pickup signal obtained by said image pickup device, said program causing said computer to function as a light exposure control section for determining a combination of a gain value to be set to a gain control section, which is provided for controlling a gain value of a predetermined image signal, which is based on an image pickup signal from said image pickup device, based on photometry data acquired based on the image pickup signal by a photometry section so that the photometry data may be kept substantially fixed and a flickering component originating from blinking of a light source may be suppressed and a shutter speed which is to be set to a shutter speed setting section, which is provided for changing over the shutter speed of an electronic shutter of said image pickup device and with which the flickering component originating from the blinking of said light source can be suppressed and issuing an instruction of a negative gain value to said gain control section when an illuminance of an image pickup object acquired based on three different kinds of information including the gain value set to said gain control section, the shutter speed set to said shutter speed setting section and synchronized with the blinking of said light source and the photometry data acquired by said photometry section satisfies a condition determined in advance.

14. A computer-readable storage medium in which a program for causing a computer to execute a light exposure control process for adjusting a shutter speed of an image pickup device and a gain of an image pickup signal obtained by said image pickup device is stored, said program causing said computer to function as a light exposure control section for determining a combination of a gain value to be set to a gain control section, which is provided for controlling a gain value of a predetermined image signal, which is based on an image pickup signal from said image pickup device, based on photometry data acquired based on the image pickup signal by a photometry section so that the photometry data may be kept substantially fixed and a flickering component originating from blinking of a light source may be suppressed and a shutter speed which is to be set to a shutter speed setting section, which is provided for changing over the shutter speed of an electronic shutter of said image pickup device and with which the flickering component originating from the blinking of said light source can be suppressed, and issuing an instruction of a negative gain value to said gain control section when an illuminance of an image pickup object acquired based on three different kinds of information including the gain value set to said gain control section, the shutter speed set to said shutter speed setting section and synchronized with the blinking of said light source and the photometry data acquired by said photometry section satisfies a condition determined in advance.
